(19) United States
(12) Patent Application Publication
(10) Pub. No.: US 2007/0001824 A1
(43) Pub. Date: Jan. 4, 2007

(54) Personalized vehicle alarm

(76) Inventor: Donna Lee Fell, Kingstowne, VA (US)

Correspondence Address: DONNA LEE FELL;BLUE SKIES VISIONS, UNIT E, 6101 WIGMORE LANE, KINGSTOWNE, VA, 22315, US

(21) Appl. No.: 11/472,340

(22) Filed: Jun. 22, 2006

Related U.S. Application Data
(60) Provisional application No. 60/693,065, filed on Jun. 23, 2005.

(51) Int. Cl. G08B 3/10

(52) U.S. Cl. 340/384.7

(57) ABSTRACT

A vehicle alarm system that can sound in any variety of tones, sounds, sequences, songs, melodies, tunes and/or any other prerecorded or individually created and/or determined phrases, statements, songs, tunes, tones, etc.

### CROSS-REFERENCE TO RELATED APPLICATIONS

Provisional Patent No. 60/693,065, filed 23 Jun. 2005.

### STATEMENT REGARDING FEDERALLY SPONSORED RESEARCH OR DEVELOPMENT

Not Applicable

### BACKGROUND OF THE INVENTION

This invention is to personalize vehicle alarms so that when a vehicle alarm sounds, the owner of a vehicle can easily recognize whether or not it is his/her vehicle that is in distress.

Presently, whenever a car alarm sounds, there isn't any way to determine which vehicle's alarm is sounding without being within eyesight where you can see the lights flashing on the vehicle. This creates quite a problem as car alarms regularly sound while vehicles are in parking lots and the owner is shopping, or at work, or in their home, etc. Oftentimes, the alarm can be heard in these locations and those within earshot run out to see if it is their vehicle in distress and/or needing attention. Vehicle alarms sound for any number of reasons, from tampering, to road vibration and the problem has gotten to be monumental and annoying.

This invention, the personalized vehicle alarm, effectively and efficiently resolves the problem of not being able to recognize the source of the alarm. This innovative device will allow the owner of a vehicle to personalize his/her alarm to sound in any variety of preprogrammed tones, sounds, songs, melodies, or tunes. In addition, the device can be personalized where the alarm will sound in any phrase, statement, name, etc., as determined by the owner. This will allow the owner of a vehicle to easily recognize when this/her vehicle needs attention.

### BRIEF SUMMARY OF THE INVENTION

The personalized vehicle alarm is an alarm that can be programmed to sound in any number of sounds that will allow for a vehicle owner to easily identify that it is his/her vehicle that needs attention.

This alarm can be programmed or manufactured to emit any variety of sounds.

The alarm can be produced as a fully operating car alarm system or existing systems can be fitted with a device allowing these alarms to function in the “personalized” mode.

What I claim as my invention is:

1. Vehicle alarm system, part, program and/or function

2. The vehicle alarm system of claim 1 whereby alarm is personalized

3. A vehicle alarm system, part, program and/or function of claim 1 whereby the alarm sounds in any variety of preprogrammed and/or individually created/determined tones, sounds, sequences, songs, melodies, tunes or any other prerecorded or personally recorded/determined phrases, statements, songs, tones, tunes, etc.
